(19) United States
(12) Patent Application Publication
(10) Pub. No.: US 2014/0368460 A1
(43) Pub. Date: Dec. 18, 2014

(54) TOUCH DETECTION METHOD AND APPARATUS, AND TOUCH SCREEN SYSTEM

(71) Applicant: FocalTech Systems, Ltd., Grand Cayman (KY)

(72) Inventors: Lianghua MO, Guangdong (CN); Wenyong LONG, Guangdong (CN); Xiangyong XIE, Guangdong (CN)

(73) Assignee: FocalTech Systems, Ltd., Grand Cayman (KY)

(21) Appl. No.: 14/080,906

(22) Filed: Nov. 15, 2013

(30) Foreign Application Priority Data
Jun. 13, 2013 (CN) 201310233407.4

(51) Int. Cl. G06F 3/041; G06F 3/044

(52) U.S. Cl. CPC G06F 3/0416; G06F 3/044
USPC 345/174

(57) ABSTRACT

The application discloses a touch detection method, a touch detection apparatus and a touch screen system. The touch detection method utilizes a closure strategy to close certain detection processes among three detection processes comprising a Y-direction electrode array detection, an X-direction electrode array detection and an XY-direction electrode array detection. Specifically, when it is detected in one of the three detection processes that no touch signal is generated on the touch screen, the other two of the three detection processes are not to be started; when it is determined that the touch signal on the touch screen is a multi-touch signal, one of the Y-direction electrode array detection and the X-direction electrode array detection that has not been executed is refrained from being started.

### CROSS REFERENCE TO RELATED APPLICATION

This application claims the benefit of priority to Chinese Patent Application No. 201310233407.4, entitled “TOUCH DETECTION METHOD AND APPARATUS, AND TOUCH SCREEN SYSTEM”, filed on Jun. 13, 2013 with State Intellectual Property Office of PRC, which is incorporated herein by reference in its entirety.

### BACKGROUND

1. Field of the Disclosure

The application relates to touch screen technology, and in particular to a touch detection method, a touch detection apparatus and a touch screen system combining self-capacitance detection and mutual-capacitance detection.

2. Background of the Technology

Capacitive touch screens are widely used in various electronic products for human-machine interaction, such as mobile phones, tablets, and large-size electronic products such as smart TVs.

There are numerous types of traditional capacitive touch screen detection layers, such as surface capacitance type, projected mutual-capacitance type, and projected self-capacitance type. The manner of mutual-capacitance detection becomes the dominant application of the capacitive touch screens due to its advantage of supporting multi-touch. The manner of self-capacitance detection supports only single-touch or dual-touch, although it has advantages of low cost, good waterproof performance, high sensitivity and the like. Therefore, to make compensation for the respective disadvantages, the self-capacitance detection and the mutual-capacitance detection are combined to obtain hybrid capacitive touch detection. In the self-capacitance detection, a Y-direction electrode array and an X-direction electrode array are detected in sequence, and an X-direction coordinate and a Y-direction coordinate are determined respectively according to the change of the capacitance due to the touch. In the mutual-capacitance detection, the Y-direction electrodes serve as the driving electrodes, the X-direction electrodes serve as the detection electrodes. The Y-direction electrodes sequentially send excitation signals while all the X-direction electrodes receive signals simultaneously, thereby determining the coupling capacitances at all the intersection points of the Y-direction electrodes and the X-direction electrodes, and thus determining coordinates of the touch.

In the existing solution combining mutual-capacitance detection and self-capacitance detection, it is required to perform both the self-capacitance detection process and the mutual-capacitance detection process, wherein the self-capacitance detection process includes a Y-direction electrode array detection and an X-direction electrode array detection, and the mutual-capacitance detection process includes an XY-direction electrode array detection. The detection data is obtained only if the above three detection processes are completed in a certain sequence. Therefore, in the solution combining mutual-capacitance detection and self-capacitance detection, the time spent for obtaining detection data is longer than the time spent in the case where only the mutual-capacitance detection or the self-capacitance detection is executed. Furthermore, with the increasing of the size of the touch screen, the number of touch detection channels is growing, and the time spent in the detection combining mutual-capacitance detection and self-capacitance detection is increasing, which significantly reduces the rate of touch detection, and meanwhile, compared with the original manner of separate mutual-capacitance detection or self-capacitance detection, power consumption is increased.

### SUMMARY

To solve the technical problems described above, the embodiments of the application provide a touch detection method and apparatus and a touch screen system to improve the rate of touch detection and reduce power consumption. The technical solution is as follows.

The application provides a touch detection method applied to a touch screen combining mutual-capacitance detection and self-capacitance detection, including:

determining, using a detection result of a first detection process, whether a touch signal is generated on a screen body of the touch screen, to obtain a first determination result, wherein the first detection process is a Y-direction electrode array detection, an X-direction electrode array detection or an XY-direction electrode array detection;

in the case that the first determination result indicating that no touch signal is generated on the screen body of the touch screen is obtained, shielding a detection process that has not been executed, wherein the detection process that has not been executed is a detection process among the three detection processes comprising the Y-direction electrode array detection, the X-direction electrode array detection and the XY-direction electrode array detection, which is different from the first detection process;

in the case that the first determination result indicating that a touch signal is generated on the screen body of the touch screen is obtained, determining the touch type of the touch signal by the detection result of the first detection process or a second detection process, to obtain a second determination result, wherein the touch type includes single-touch and multi-touch, and the second detection process is one of the three detection processes which is different from the first detection process;

in the case that the second determination result indicating that the touch signal is a multi-touch signal is obtained, refraining from starting a self-capacitance detection process that has not been executed; and

obtaining touch information corresponding to the touch signal according to the detection results of the detection processes that have been executed.

Preferably, the touch detection method further includes: in the case that the second determination result indicating that the touch signal is a single-touch signal is obtained, starting the self-capacitance detection process that has not been executed.

Preferably, in the case where the detection processes that have been executed include the Y-direction electrode array detection, the X-direction electrode array detection and the XY-direction electrode array detection, obtaining touch information corresponding to the touch signal according to the detection results of the detection processes that have been executed includes:

obtaining first coordinate information corresponding to the touch signal according to the detection results of the Y-direction electrode array detection and the X-direction electrode array detection;

obtaining second coordinate information corresponding to the touch signal according to the detection result of the XY-direction electrode array detection; and

averaging the first coordinate information and the second coordinate information to obtain coordinate information corresponding to the touch signal.

Preferably, when the first detection process is the Y-direction electrode array detection and the second detection process is the XY-direction electrode array detection, the self-capacitance detection process that has not been executed is the X-direction electrode array detection;

when the first detection process is the X-direction electrode array detection and the second detection process is the XY-direction electrode array detection, the self-capacitance detection process that has not been executed is the Y-direction electrode array detection; and

when the first detection process is the XY-direction electrode array detection, the self-capacitance detection process that has not been executed includes the X-direction electrode array detection and the Y-direction electrode array detection.

Preferably, in the case where the first detection process is the Y-direction electrode array detection or the X-direction electrode array detection and the second detection process is the XY-direction electrode array detection, after determining that a touch signal is generated on the screen body of the touch screen according to the detection result of the first detection process, and before starting the second detection process, the method further includes:

determining an electrode-scanning range of the second detection process according to the detection result of the first detection process.

The application also provides a touch detection apparatus applied to a touch screen combining mutual-capacitance detection and self-capacitance detection, including: a detection process starting unit, a touch signal detecting unit, a touch signal type determining unit, a shielding unit, and a touch information acquiring unit, wherein

the detection process starting unit is adapted to start a first detection process, wherein the first detection process is a Y-direction electrode array detection, an X-direction electrode array detection or an XY-direction electrode array detection;

the touch signal detecting unit is adapted to determine, according to the detection result of the first detection process, whether a touch signal is generated on a screen body of the touch screen, to obtain a first determination result;

the detection process starting unit is further adapted to start a second detection process in the case that the first determination result obtained from the touch signal detecting unit indicates that a touch signal is generated on the screen body of the touch screen and the first detection process is the X-direction electrode array detection or the Y-direction electrode array detection, wherein the second detection process is any one of the three detection processes: the Y-direction electrode array detection, the X-direction electrode array detection and the XY-direction electrode array detection, which is different from the first detection process;

the touch signal type determining unit is adapted to determine, in the case that the first determination result indicating that a touch signal is generated on the screen body of the touch screen is obtained, the touch type of the touch signal according to the detection result of the first detection process or the second detection process, to obtain a second determination result, wherein the touch type includes single-touch and multi-touch;

the shielding unit is adapted to refrain from starting a detection process that has not been executed in the case that the first determination result indicating that no touch signal is generated on the screen body of the touch screen is obtained, and to refrain from starting a self-capacitance detection process that has not been executed in the case that the second determination result indicating that the touch signal is a multi-touch signal is obtained, wherein the detection process that has not been executed is a detection process among the three detection processes comprising the Y-direction electrode array detection, the X-direction electrode array detection and the XY-direction electrode array detection, which is different from the first detection process; and

the touch information acquiring unit is adapted to obtain touch information corresponding to the touch signal according to the detection results of the detection processes that have been executed.

Preferably, the detection process starting unit is further adapted to start the self-capacitance detection process that has not been executed in the case that the second determination result indicating that the touch signal is a single-touch signal is obtained.

Preferably, the touch information acquiring unit includes a first coordinate acquiring unit, a second coordinate acquiring unit and a coordinate information acquiring unit;

the first coordinate acquiring unit is adapted to obtain first coordinate information corresponding to the touch signal according to the detection results of the Y-direction electrode array detection and the X-direction electrode array detection;

the second coordinate acquiring unit is adapted to obtain second coordinate information corresponding to the touch signal according to the detection result of the XY-direction electrode array detection; and

the coordinate information acquiring unit is adapted to average the first coordinate information and the second coordinate information to obtain coordinate information corresponding to the touch signal.

Preferably, the touch detection apparatus further includes:

a scan range determination unit, adapted to determine an electrode-scanning range of the second detection process according to the detection result of the first detection process when the first detection process is the Y-direction electrode array detection or the X-direction electrode array detection and the second detection process is the XY-direction electrode array detection.

The application also provides a touch screen system, including a screen body, a touch screen detection sub-system, a main processor and the touch detection apparatus described above, wherein:

the touch screen detection sub-system is adapted to perform touch detection on the screen body of the touch screen according to a detection strategy of the touch detection apparatus, and supply the obtained detection result to the touch detection apparatus; and

the touch detection apparatus is adapted to obtain touch information corresponding to the touch signal generated on the screen body according to the detection result and supply the touch information to the main processor.

Preferably, the touch screen detection sub-system includes: a sensing channel module, a channel scanning module, a channel driving module and a memory, wherein

the channel scanning module is adapted to control, according to the detection strategy of the touch detection apparatus, the channel driving module to send an excitation signal to the screen body, and control the sensing channel module to receive and detect the excitation signal;

the sensing channel module is adapted to obtain the detection result after receiving and detecting the excitation signal, and supply the detection result to the channel scanning module; and

the channel scanning module is adapted to supply the received detection result to the memory for storing.

It can be seen from the above technical solutions provided by the embodiments of the application that, in the touch detection method, by utilizing a closure strategy, some of the three detection processes comprising the Y-direction electrode array detection, the X-direction electrode array detection and the XY-direction electrode array detection can be closed. Therefore, as compared with the total time spent for executing the above three detection processes in the prior art, the time spent for the detection process that has not been executed is reduced, and thus the time spend for acquiring touch information corresponding to the touch signal is reduced and the rate of touch detection is improved. Since some detection processes do not need to be started, power consumption is reduced. Specifically, when a certain one of the three detection processes described above detects that no touch signal is generated on the touch screen, the other two of the three detection processes that have not been executed are not to be started; and when it is determined that the touch signal on the touch screen is a multi-touch signal, one of the two detection processes including the Y-direction electrode array detection and the X-direction electrode array detection that has not been executed is refrained from being started. The more detection processes are closed, the more time is saved, and the lower power consumption is.

In addition, in the touch detection method provided by embodiments of the invention, the determination conditions for determining whether a touch signal is generated on the touch screen and determining the touch type of the touch signal can also be changed to be determination conditions required in various other applications as the basis of deciding to close a detection process and adjusting the sequence of the detection processes. Furthermore, in the touch detection method, it is also possible to arbitrarily adjust the sequence of the three detection processes in the detection as required.

### BRIEF DESCRIPTION OF THE DRAWINGS

In order to more clearly illustrate the technical solutions in the embodiments of the application or in the prior art, drawings used in the description of the embodiments or the prior art will be introduced briefly hereinafter. Apparently, the drawings in the description below are merely some embodiments disclosed in the application, and for those of ordinary skill in the art, other drawings can be obtained from these drawings without any creative labors.

FIG. 1 is a schematic flow chart of a touch detection method according to an embodiment of the application;

FIG. 2 is a schematic flow chart of a touch detection method according to another embodiment of the application;

FIG. 3 is a schematic flow chart of a touch detection method according to another embodiment of the application;

FIG. 4 is a schematic structural diagram of a touch detection apparatus according to an embodiment of the application;

FIG. 5 is a schematic structural diagram of a touch detection apparatus according to another embodiment of the application;

FIG. 6 is a schematic structural diagram of a touch detection apparatus according to another embodiment of the application; and

FIG. 7 is a schematic structural diagram of a touch screen system according to an embodiment of the application.

### DETAILED DESCRIPTION

The embodiments of the application provide a touch detection method, a touch detection apparatus, and a touch screen system, in which a closure strategy is added in the touch detection such that some of three detection processes, namely a Y-direction electrode array detection, an X-direction electrode array detection and an XY-direction electrode array detection, contained in the self-capacitance detection and the mutual-capacitance detection, can be omitted. Thus the time required for the closed detection processes is saved and power consumption is reduced. The reporting rate for the touch signal is improved since the detection time is shortened. Furthermore, for the touch detection method the sequence of the three detection processes may be changed as required, thereby improving the flexibility of touch detection.

Specifically, the core idea of the closure strategy lies in that: firstly, it is determined whether a touch signal is generated on the touch screen, which, specifically, can be done by using any one of the above three detection processes; if no touch signal is generated on the touch screen, the detection process(s) among the above three detection processes that has not been executed is refrained from being started; if a touch signal is generated on the touch screen, it is further determined whether the touch signal is a multi-touch signal, and specifically, if the touch signal is a multi-touch signal, the self-capacitance detection process that has not been executed is refrained from being started; and touch information corresponding to the touch signal is obtained according to the detection results of the detection processes that have been executed.

For better understanding of the technical solution in the application by those skilled in the art, the technical solution in the embodiments of the application will be clearly and completely described hereinafter in conjunction with drawings. Apparently, the embodiments described are merely some embodiments of the application, rather than all embodiments. All other embodiments obtained based on the embodiments in the application by those skilled in the art without any creative works should fall within the scope of protection of the application.

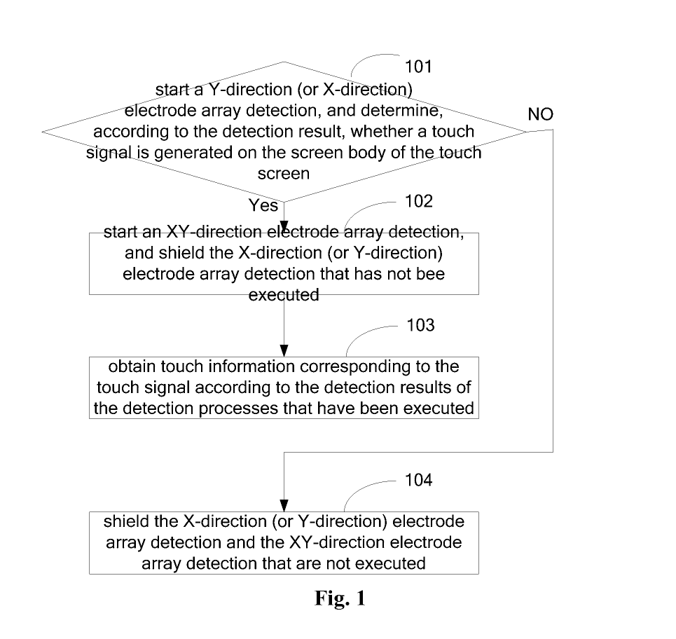

Referring to FIG. 1 which shows a schematic flow chart of a touch detection method according to an embodiment of the application, the touch detection method applied to a touch screen combining mutual-capacitance detection and self-capacitance detection includes steps 101-104.

step 101, starting a Y-direction electrode array detection (or an X-direction electrode array detection); determining, according to the detection result of the Y-direction electrode array detection (or the X-direction electrode array detection), whether a touch signal is generated on the screen body of the touch screen; and if it is determined that a touch signal is generated on the screen body of the touch screen, performing step 102; or otherwise, performing step 104;

step 102, starting an XY-direction electrode array detection, and shielding the X-direction electrode array detection (or the Y-direction electrode array detection) that has not been executed;

step 103, obtaining touch information corresponding to the touch signal according to the detection results of the detection processes that have been executed; and

step 104, shielding the X-direction electrode array detection (or the Y-direction electrode array detection) and the XY-direction electrode array detection that are not executed.

Shielding the detection process that has not been executed means not starting the detection process that has not been executed.

In the touch detection method provided by this embodiment, the detection process that has not been executed is shielded, which saves the time required for the detection process that has not been executed as compared with the existing method of detection in which all the above three detection processes must be completed. Therefore, the rate of touch detection is increased and the power consumption is reduced.

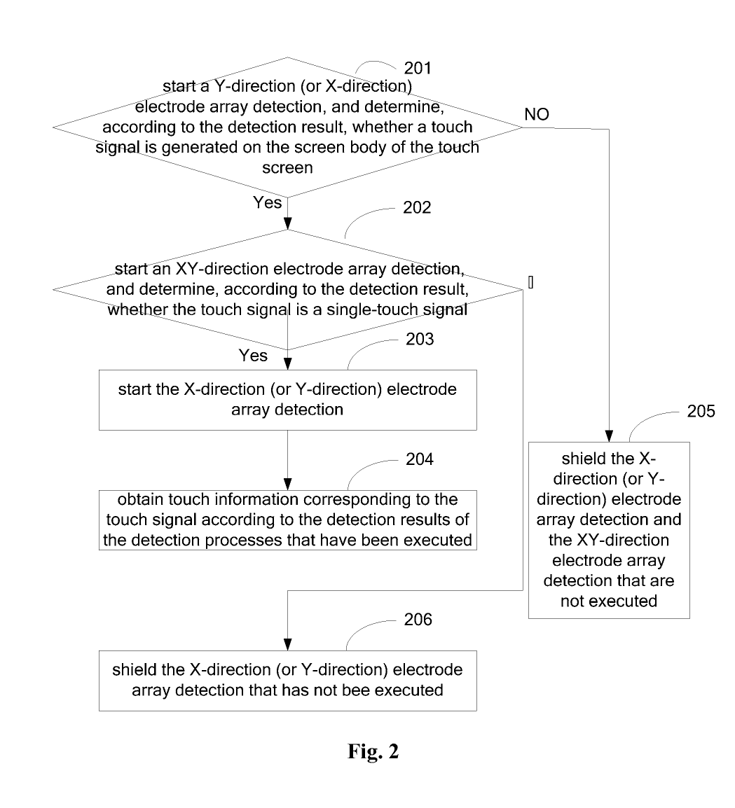

Referring to FIG. 2 which shows a schematic flow chart of another touch detection method according to another embodiment of the application, the touch detection method applied to a touch screen combining mutual-capacitance detection and self-capacitance detection includes the following steps 201-206.

Step 201, starting a Y-direction electrode array detection (or an X-direction electrode array detection); determining, according to the detection result of the Y-direction electrode array detection (or the X-direction electrode array detection), whether a touch signal is generated on the screen body of the touch screen; and if it is determined that a touch signal is generated on the screen body of the touch screen, performing step 202; or otherwise, performing step 205.

Step 202, starting an XY-direction electrode array detection; and determining the touch type of the touch signal according to the detection result of the XY-direction electrode array detection, wherein the touch type includes single-touch and multi-touch; and if the touch signal is a single-touch signal, performing step 203; or if the touch signal is a multi-touch signal, performing step 206.

Step 203, starting the X-direction electrode array detection (or the Y-direction electrode array detection).

Step 204, obtaining touch information corresponding to the touch signal according to the detection results of the detection processes that have been executed.

Preferably, in the case where the detection processes that have been executed include the Y-direction electrode array detection, the X-direction electrode array detection and the XY-direction electrode array detection, the step 204 includes:

obtaining first coordinate information corresponding to the touch signal according to the detection result of the X-direction electrode array detection and the detection result of the Y-direction electrode array detection;

obtaining second coordinate information corresponding to the touch signal according to the detection result of the XY-direction electrode array detection; and

averaging the first coordinate information and the second coordinate information to obtain coordinate information corresponding to the touch signal.

In the case where the detection processes that have been executed include the Y-direction electrode array detection (or the X-direction electrode array detection) and the XY-direction electrode array detection, the step 204 includes: obtaining coordinate information corresponding to the touch signal according to the detection result of the XY-direction electrode array detection.

Step 205, shielding the X-direction electrode array detection (or the Y-direction electrode array detection) and the XY-direction electrode array detection that have not been executed.

Shielding the detection process that has not been executed refers to not starting the detection process that has not been executed.

Step 206, shielding the X-direction electrode array detection (or the Y-direction electrode array detection) that has not been executed.

In the touch detection method provided by this embodiment, in the case where the touch signal is a single-touch signal, there is a time difference between the Y-direction electrode array detection and the X-direction electrode array detection, which can prevent the X-direction electrode array detection and the Y-direction electrode array detection from both being interfered, and thus improve accuracy of touch detection. In addition, since the coordinate information of the single-touch is obtained by averaging the coordinates of the single-touch obtained by the self-capacitance detection and the coordinates of the single-touch obtained by the mutual-capacitance detection, the coordinate information of the single-touch is smoother, and thus the fluency of single-point operations is improved.

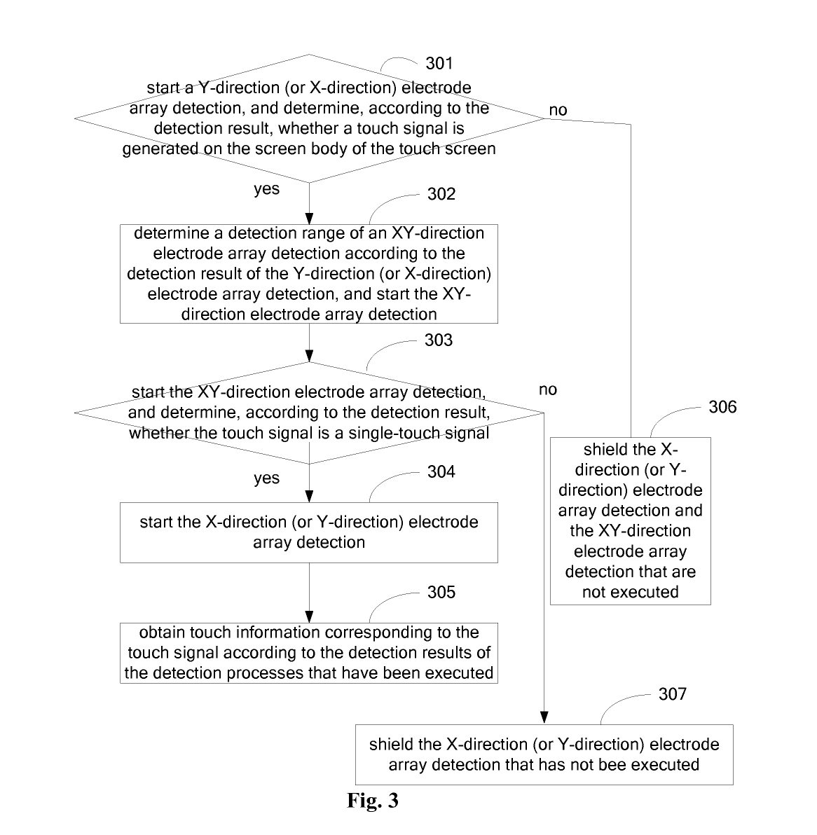

Referring to FIG. 3, another touch detection method according to an embodiment of the application is shown, which differs from the embodiment in FIG. 2 in that a process for determining a scan range of the XY-direction electrode array is added in the detection. This touch detection method is applied to a touch screen combining mutual-capacitance detection and self-capacitance detection, and includes the steps 301-307.

Step 301, starting a Y-direction electrode array detection (or an X direction electrode array detection); determining, according to the detection result of the Y-direction electrode array detection, whether a touch signal is generated on the screen body of the touch screen; and if it is determined that that a touch signal is generated on the screen body of the touch screen, performing step 302; or otherwise, performing step 306.

Step 302, determining a detection range of an XY-direction electrode array detection according to the detection result of the Y-direction electrode array detection (or the X-direction electrode array detection), and starting the XY-direction electrode array detection.

Step 303, determining the touch type of the touch signal according to the detection result of the XY-direction electrode array detection, wherein the touch type includes single-touch and multi-touch; and if the touch signal is a single-touch signal, performing step 304; or if the touch signal is a multi-touch signal, performing step 307.

Step 304, starting the X-direction electrode array detection (or the Y-direction electrode array detection).

Step 305, obtaining touch information corresponding to the touch signal according to the detection results of the detection processes that have been executed.

For the specific implementation of this step, one can refer to the relevant description of FIG. 2, which will not be repeated herein.

Step 306, shielding the X-direction electrode array detection (or the Y-direction electrode array detection) and the XY-direction electrode array detection that have not been executed.

Shielding the detection process that has not been executed refers to not starting the detection process that has not been executed.

Step 307, shielding the X-direction electrode array detection (or the Y-direction electrode array detection) that has not been executed.

In the touch detection method provided by this embodiment, not only the time required for the detection process that has not been executed is saved and the rate of touch detection is improved, the scan range of the XY-direction electrode array detection can be determined according to the previously-executed Y-direction electrode array detection or X-direction electrode array detection. Therefore, there is no need to drive all the Y-direction electrodes, and thus the detection time of the XY-direction electrode array detection is shortened, the efficiency of touch detection is improved, and the power consumption of the XY-direction electrode array detection is reduced.

It should be noted that, the touch detection method provided by the application is the detection method for one touch detection operation, and for multiple touch detection, the above touch detection method is required to be repeated.

Accordingly, the application also provides a touch detection apparatus corresponding to the method embodiments described above.

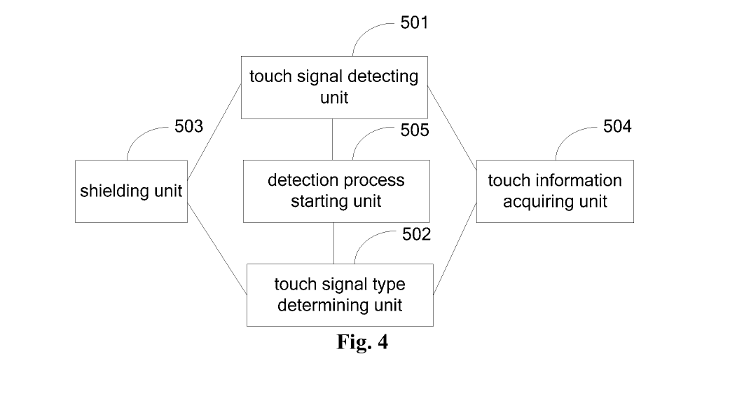

Referring to FIG. 4, a schematic structural view of a touch detection apparatus provided by an embodiment of the invention is shown, and the touch detection apparatus applied to a touch screen combining mutual-capacitance detection and self-capacitance detection includes: a touch signal detecting unit 501, a touch signal type determining unit 502, a shielding unit 503, a touch information acquiring unit 504 and a detection process starting unit 505.

The detection process starting unit 505 is adapted to start a first detection process.

The touch signal detecting unit 501 is adapted to determine, according to the detection result of the first detection process, whether a touch signal is generated on a screen body of the touch screen, to obtain a first determination result.

The first detection process is any one of a Y-direction electrode array detection, an X-direction electrode array detection and an XY-direction electrode array detection.

The detection process starting unit 505 is further adapted to start a second detection process in the case that the first determination result indicating that a touch signal is generated on the screen body of the touch screen is obtained and the first detection process is a self-capacitance detection process, wherein the second detection process is any one of the Y-direction electrode array detection, the X-direction electrode array detection and the XY-direction electrode array detection, which is different from the first detection process.

The touch signal type determining unit 502 is adapted to determine, in the case that the first determination result indicating that a touch signal is generated on the screen body of the touch screen is obtained, the touch type of the touch signal according to the detection result of the first detection process or the second detection process, to obtain a second determination result.

The touch type includes single-touch and multi-touch.

In a specific implementation, when the first detection process is one of self-capacitance detection processes, it is required to determine the touch type of the touch signal according to the detection result of the second detection process.

In the case where the first detection process is a mutual-capacitance detection process (the XY-direction electrode array detection), not only whether a touch signal is generated on the screen body of the touch screen can be determined by the XY-direction electrode array detection, but also the touch type of the touch signal can be determined.

The shielding unit 503 is adapted to refrain from starting the detection process that has not been executed in the case that the first determination result indicating that no touch signal is generated on the touch body of the touch screen is obtained, and to refrain from starting the self-capacitance detection process that has not been executed in the case that the second detection result indicating that the touch signal is a multi-touch signal is obtained.

The detection process that has not been executed is a detection process among the Y-direction electrode array detection, the X-direction electrode array detection and the XY-direction electrode array detection, which is different from the first detection process.

For the self-capacitance detection process that has not been executed, there are the following cases: when the first detection process is the X-direction electrode array detection and the second detection process is the XY-direction electrode array detection, the self-capacitance detection process that has not been executed is the Y-direction electrode array detection;

when the first detection process is the Y-direction electrode array detection and the second detection process is the XY-direction electrode array detection, the self-capacitance detection process that has not been executed is the X-direction electrode array detection; and

when the first detection process is the XY-direction electrode array detection, the self-capacitance detection process that has not been executed includes the X-direction electrode array detection and the Y-direction electrode array detection.

The touch information acquiring unit 504 is adapted to obtain touch information corresponding to the touch signal according to the detection results of the detection processes that have been executed.

For the touch detection apparatus provided by this embodiment, a closure strategy is added such that some of the three detection processes, namely the Y-direction electrode array detection, the X-direction electrode array detection and the XY-direction electrode array detection, can not be started. Therefore, the time required for the closed detection processes is saved and power consumption is reduced. Since the detection time is shortened, the reporting rate for the touch signal is improved. Furthermore, for the touch detection method, the sequence of the three detection processes may be changed as required, thereby improving the flexibility of touch detection.

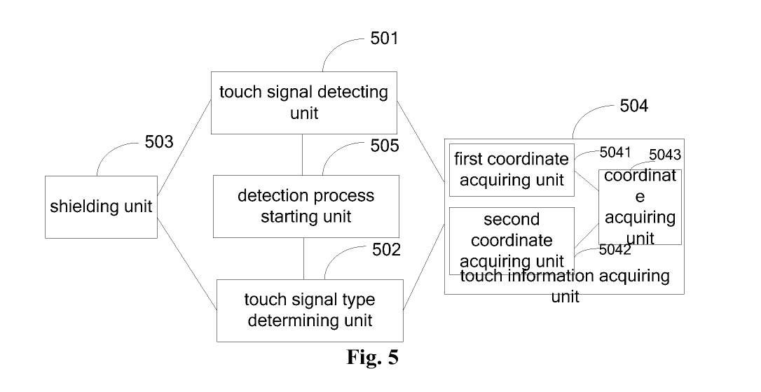

Referring to FIG. 5, a schematic structural view of another touch detection apparatus of the application is shown, which differs from the touch detection apparatus in FIG. 4 in that the detection process starting unit 505 is further adapted to start the self-capacitance detection process that has not been executed, in the case that the second determination result obtained from the touch signal type determining unit indicates that the touch signal is a single-touch signal.

Specifically, when the touch signal type determining unit 502 determines that the touch signal is a single-touch signal, the detection process starting unit 505 starts an X-direction electrode array detection or a Y-direction electrode array detection.

At this time, the touch information acquiring unit 504 is adapted to average the coordinates of the touch signal obtained by the self-capacitance detection process and the coordinates of the touch signal obtained by the mutual-capacitance detection process, and use the obtained average value as the final coordinate information corresponding to the touch signal.

In a specific implementation, the touch information acquiring unit 504 may include: a first coordinate acquiring unit 5041, a second coordinate acquiring unit 5042 and a coordinate acquiring unit 5043.

The first coordinate acquiring unit 5041 is adapted to obtain first coordinate information corresponding to the touch signal according to the detection results of the Y-direction electrode array detection and the X-direction electrode array detection.

The second coordinate acquiring unit 5042 is adapted to obtain second coordinate information corresponding to the touch signal according to the detection result of the XY-direction electrode array detection.

The coordinate acquiring unit 5043 is adapted to average the first coordinate information and the second coordinate information to obtain coordinate information corresponding to the touch signal.

The touch detection apparatus provided by this embodiment starts the self-capacitance detection process that has not been executed after determining that the touch signal generated on the screen body of the touch screen is a single-touch signal, and averages the coordinates of the touch signal obtained by the self-capacitance detection process and the coordinates of the touch signal obtained by the mutual-capacitance detection process. The obtained average value is used as the coordinate information corresponding to the touch signal, such that the coordinates of the single-touch signal are smoother, thereby improving the fluency of single-touch operations.

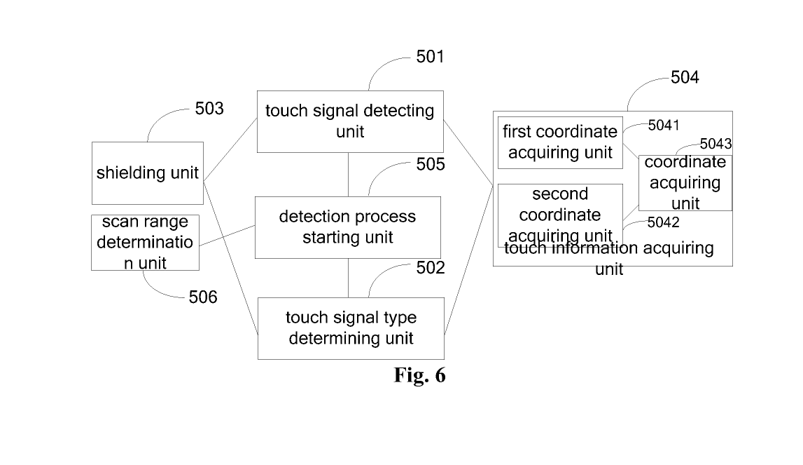

Referring to FIG. 6, a schematic structural view of another touch detection apparatus of an embodiment of the invention is shown, which differs from the touch detection apparatus in FIG. 5 in that it further includes a scan range determination unit 506.

When the first detection process is the Y-direction electrode array detection or the X-direction electrode array detection and the second detection process is the XY-direction electrode array detection, the scan range determination unit 506 determines the electrode scanning range of the XY-direction electrode array detection (the second detection process) according to the detection result of the first detection process.

Specifically, when the Y-direction electrode array detection detects that a touch signal is generated on the screen body of the touch screen, the scan range of the XY-direction electrode array is determined according to the detection result of the Y-direction electrode array detection without driving all the Y-direction electrodes, which reduces the scan range of the XY-direction electrode array, improves the detection rate of the XY-direction electrode array detection, and reduces power consumption.

Accordingly, the application also provides a touch screen system corresponding to the method and apparatus embodiments described above.

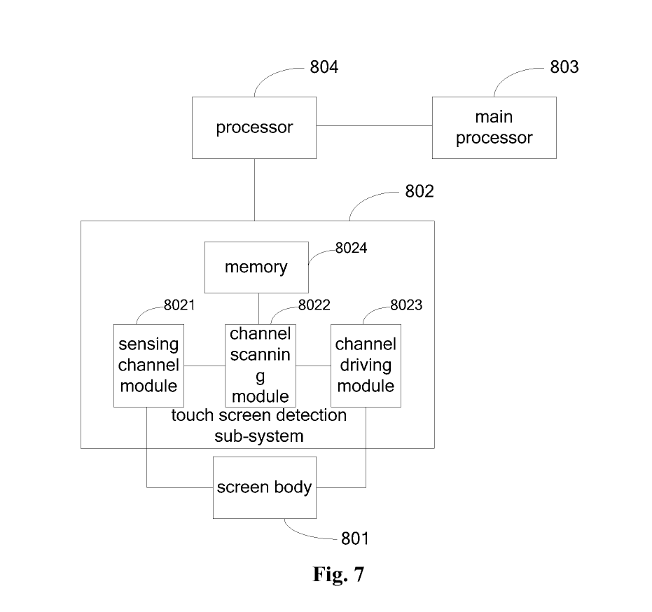

Referring to FIG. 7, a schematic structural view of a touch screen system is shown. The touch screen system includes a screen body 801, a touch screen detection sub-system 802, a main processor 803, and the touch detection apparatus provided by the above-described embodiments, wherein the touch detection apparatus is integrated into a processor 804.

The touch screen detection sub-system 802 is adapted to perform touch detection on the screen body of the touch screen according to a detection strategy of the touch detection apparatus, and supply the obtained detection result to the touch detection apparatus.

The processor 804 is adapted to obtain touch information corresponding to the touch signal generated on the screen body according to the detection result, and supply the touch information to the main processor 803.

The touch information includes coordinate information, pressure information, touch area and other relevant information of a touch point corresponding to a touch operation on the screen body.

In a specific implementation, the touch screen detection sub-system 802 includes: a sensing channel module 8021, a channel scanning module 8022, a channel driving module 8023 and a memory 8024.

The channel scanning module 8022 is adapted to control, according to the detection strategy of the processor 804, the channel driving module 8023 to send an excitation signal to the screen body, and meanwhile control the sensing channel module 8021 to receive and detect the excitation signal.

The sensing channel module 8021 is adapted to obtain the detection result after receiving and detecting the excitation signal, and supply the detection result to the channel scanning module.

The channel scanning module 8022 is adapted to supply the received detection result to the memory for storing.

The memory 8024 can supply the detection result to the processor 804 for corresponding processing.

In the touch screen system provided by this embodiment, information of a touch on the screen body is detected according to a detection strategy in the processor. The detection strategy saves the time required for the detection process that has not been executed as compared with the existing manners of detection in which all the three detection processes described above must be completed. Therefore the rate of touch detection is improved and power consumption is reduced. In the method provided by this embodiment, there is a certain time difference between the Y-direction electrode array detection and the X-direction electrode array detection, which can prevent the X-direction electrode array detection and the Y-direction electrode array detection from being disturbed simultaneously, and thus improve the accuracy of touch detection.

The various embodiments of the present specification all are described in a progressive manner. The same or similar parts among the embodiments can be referred by each other, and each embodiment emphasizes on the difference from other embodiments. In particular, since the apparatus or system embodiments are substantially similar with the method embodiments, the description for them are relatively simple and the corresponding parts of illustration of the method embodiments can be referred for the related parts. The apparatus or system embodiments described above are merely for illustration. Specifically, the units described as separate components can be or can be not separated physically, the component illustrated as a unit can be or can be not a physical unit. That is, it can be provided at a single location or can be distributed over multiple network units. Some or all of the modules can be selected to achieve the aim of the solutions of the embodiments as required in practice. The embodiments can be understood and implemented by those of ordinary skill in the art without an inventive work.

It should be noted that, relations terms such as “a first” and “a second” are merely used to distinguish an entity or operation from another entity or operation, and do not necessarily require or imply that there is any such actual relation or order between the entities or operations.

The above description is merely specific implementations of the application. It should be noted that, those of ordinary skill in the art can also make various changes and modifications without departure from the principle of the application, and these changes and modifications should also be deemed as falling within the scope of protection of the application.

What is claimed is:

1. A touch detection method applied to a touch screen combining mutual-capacitance detection and self-capacitance detection, the method comprising:
determining, using a detection result of a first detection process, whether a touch signal is generated on a screen body of the touch screen, to obtain a first determination result, wherein the first detection process is a Y-direction electrode array detection, an X-direction electrode array detection or an XY-direction electrode array detection;
in the case that the first determination result indicating that no touch signal is generated on the screen body of the touch screen is obtained, shielding a detection process that has not been executed, wherein the detection process that has not been executed is a detection process among three detection processes comprising the Y-direction electrode array detection, the X-direction electrode array detection and the XY-direction electrode array detection, which is different from the first detection process;
in the case that the first determination result indicating that a touch signal is generated on the screen body of the touch screen is obtained, determining the touch type of the touch signal according to a detection result of the first detection process or a second detection process, to obtain a second determination result, wherein the touch type comprises single-touch and multi-touch, and the second detection process is one of the three detection processes which is different from the first detection process;
in the case that the second determination result indicating that the touch signal is a multi-touch signal is obtained, refraining from starting a self-capacitance detection process that has not been executed; and
obtaining touch information corresponding to the touch signal according to the detection results of the detection processes that have been executed.

2. The touch detection method according to claim 1, further comprising: in the case that the second determination result indicating that the touch signal is a single-touch signal is obtained, starting the self-capacitance detection process that has not been executed.

3. The touch detection method according to claim 2, wherein in the case where the detection processes that have been executed comprise the Y-direction electrode array detection, the X-direction electrode array detection and the XY-direction electrode array detection, obtaining touch information corresponding to the touch signal according to the detection results of the detection processes that have been executed comprises:
obtaining first coordinate information corresponding to the touch signal according to the detection results of the Y-direction electrode array detection and the X-direction electrode array detection;
obtaining second coordinate information corresponding to the touch signal according to the detection result of the XY-direction electrode array detection; and
averaging the first coordinate information and the second coordinate information to obtain coordinate information corresponding to the touch signal.

4. The touch detection method according to claim 1, wherein
when the first detection process is the Y-direction electrode array detection and the second detection process is the XY-direction electrode array detection, the self-capacitance detection process that has not been executed is the X-direction electrode array detection;
when the first detection process is the X-direction electrode array detection and the second detection process is the XY-direction electrode array detection, the self-capacitance detection process that has not been executed is the Y-direction electrode array detection; and
when the first detection process is the XY-direction electrode array detection, the self-capacitance detection process that has not been executed comprises the X-direction electrode array detection and the Y-direction electrode array detection.

5. The touch detection method according to claim 1, wherein in the case where the first detection process is the Y-direction electrode array detection or the X-direction electrode array detection and the second detection process is the XY-direction electrode array detection, after determining that a touch signal is generated on the screen body of the touch screen according to the detection result of the first detection process, and before starting the second detection process, the method further comprises:
determining an electrode-scanning range of the second detection process according to the detection result of the first detection process.

6. A touch detection apparatus applied to a touch screen combining mutual-capacitance detection and self-capacitance detection, comprising: a detection process starting unit, a touch signal detecting unit, a touch signal type determining unit, a shielding unit and a touch information acquiring unit, wherein
the detection process starting unit is adapted to start a first detection process, wherein the first detection process is a Y-direction electrode array detection, an X-direction electrode array detection or an XY-direction electrode array detection;
the touch signal detecting unit is adapted to determine, according to a detection result of the first detection process, whether a touch signal is generated on a screen body of the touch screen, to obtain a first determination result;
the detection process starting unit is further adapted to start a second detection process in the case that the first determination result obtained from the touch signal detecting unit indicates that a touch signal is generated on the screen body of the touch screen and the first detection process is the X-direction electrode array detection or the Y-direction electrode array detection, wherein the second detection process is any one of the three detection processes: the Y-direction electrode array detection, the X-direction electrode array detection and the XY-direction electrode array detection, which is different from the first detection process;
the touch signal type determining unit is adapted to determine, in the case that the first determination result indicating that a touch signal is generated on the screen body of the touch screen is obtained, the touch type of the touch signal according to the detection result of the first detection process or the second detection process, to obtain a second determination result, wherein the touch type comprises single-touch and multi-touch;
the shielding unit is adapted to refrain from starting a detection process that has not been executed in the case that the first determination result indicating that no touch signal is generated on the screen body of the touch screen is obtained, and to refrain from starting a self-capacitance detection process that has not been executed in the case that the second determination result indicating that the touch signal is a multi-touch signal is obtained, wherein the detection process that has not been executed is a detection process among the three detection processes comprising the Y-direction electrode array detection, the X-direction electrode array detection and the XY-direction electrode array detection, which is different from the first detection process; and
the touch information acquiring unit is adapted to obtain touch information corresponding to the touch signal according to the detection results of the detection processes that have been executed.

7. The touch detection apparatus according to claim 6, wherein the detection process starting unit is further adapted to start the self-capacitance detection process that has not been executed in the case that the second determination result indicating that the touch signal is a single-touch signal is obtained.

8. The touch detection apparatus according to claim 7, wherein
the touch information acquiring unit comprises a first coordinate acquiring unit, a second coordinate acquiring unit and a coordinate information acquiring unit;
the first coordinate acquiring unit is adapted to obtain first coordinate information corresponding to the touch signal according to the detection results of the Y-direction electrode array detection and the X-direction electrode array detection;
the second coordinate acquiring unit is adapted to obtain second coordinate information corresponding to the touch signal according to the detection result of the XY-direction electrode array detection; and
the coordinate information acquiring unit is adapted to average the first coordinate information and the second coordinate information to obtain coordinate information corresponding to the touch signal.

9. The touch detection apparatus according to claim 6, further comprising:
a scan range determination unit, adapted to determine an electrode-scanning range of the second detection process according to the detection result of the first detection process when the first detection process is the Y-direction electrode array detection or the X-direction electrode array detection and the second detection process is the XY-direction electrode array detection.

10. A touch screen system, comprising a screen body, a touch screen detection sub-system, a main processor and a touch detection apparatus, wherein
the touch detection apparatus comprises: a detection process starting unit, a touch signal detecting unit, a touch signal type determining unit, a shielding unit and a touch information acquiring unit, wherein
the detection process starting unit is adapted to start a first detection process, wherein the first detection process is a Y-direction electrode array detection, an X-direction electrode array detection or an XY-direction electrode array detection;
the touch signal detecting unit is adapted to determine, according to a detection result of the first detection process, whether a touch signal is generated on a screen body of the touch screen, to obtain a first determination result;
the detection process starting unit is further adapted to start a second detection process in the case that the first determination result obtained from the touch signal detecting unit indicates that a touch signal is generated on the screen body of the touch screen and the first detection process is the X-direction electrode array detection or the Y-direction electrode array detection, wherein the second detection process is any one of the three detection processes: the Y-direction electrode array detection, the X-direction electrode array detection and the XY-direction electrode array detection, which is different from the first detection process;
the touch signal type determining unit is adapted to determine, in the case that the first determination result indicating that a touch signal is generated on the screen body of the touch screen is obtained, the touch type of the touch signal according to the detection result of the first detection process or the second detection process, to obtain a second determination result, wherein the touch type comprises single-touch and multi-touch;
the shielding unit is adapted to refrain from starting a detection process that has not been executed in the case that the first determination result indicating that no touch signal is generated on the screen body of the touch screen is obtained, and to refrain from starting a self-capacitance detection process that has not been executed in the case that the second determination result indicating that the touch signal is a multi-touch signal is obtained, wherein the detection process that has not been executed is a detection process among the three detection processes comprising the Y-direction electrode array detection, the X-direction electrode array detection and the XY-direction electrode array detection, which is different from the first detection process; and
the touch information acquiring unit is adapted to obtain touch information corresponding to the touch signal according to the detection results of the detection processes that have been executed;
the touch screen detection sub-system is adapted to perform touch detection on the screen body of the touch screen according to a detection strategy of the touch detection apparatus, and supply the obtained detection result to the touch detection apparatus; and
the touch detection apparatus is adapted to obtain touch information corresponding to the touch signal generated on the screen body according to the detection result and supply the touch information to the main processor.

11. The touch screen system according to claim 10, wherein the touch screen detection sub-system comprises: a sensing channel module, a channel scanning module, a channel driving module and a memory, wherein
the channel scanning module is adapted to control, according to the detection strategy of the touch detection apparatus, the channel driving module to send an excitation signal to the screen body, and control the sensing channel module to receive and detect the excitation signal;
the sensing channel module is adapted to obtain the detection result after receiving and detecting the excitation signal, and supply the detection result to the channel scanning module; and
the channel scanning module is adapted to supply the received detection result to the memory for storing.
